(19) United States
(12) Patent Application Publication
(10) Pub. No.: US 2006/0153039 A1
(43) Pub. Date: Jul. 13, 2006

(54) Optical recording apparatus

(76) Inventor: Marinus Adrianus Henricus Looijkens, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/562,891

(22) PCT Filed: Jun. 25, 2004
(86) PCT No.: PCT/IB04/51006

§ 371 Date: Dec. 29, 2005

(30) Foreign Application Priority Data
Jun. 30, 2003 (EP) 03101943.3

(51) Int. Cl. G11B 7/0045; G11B 20/10; G11B 27/36; G11B 5/09; H04N 5/76

(52) U.S. Cl. 369/59.12

(57) ABSTRACT

An optical recording apparatus (101; 201) is described, for writing information to an optical storage medium such as for instance an optical disc, the apparatus comprising a laser diode (30), an encoder device (10; 210), and a laser driver circuit (120; 220) which comprises a flipflop device (25), a write strategy generator and a laser current driver (26). A single encoded signal (S_{EFMdata}; S_{MUX}) containing data information and clock information is transferred over one common transfer path (14) from the encoder (10; 210) to the driver circuit (120; 220), which further comprises signal generator means (130; 230) designed to generate a digital data signal (S_{EFMdata}) and a digital clock signal (S_{CLK}) from the single encoded signal received from the encoder.

### FIELD OF THE INVENTION

The present invention relates in general to an optical recording apparatus for writing information into an optical storage medium, more particularly but not necessarily exclusively an optical storage disc. Hereinafter, the present invention will be explained for the case of an optical storage disc, and the apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writable type, where information may be stored by a user. For writing information in the storage space of a writable optical storage disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, and the way in which information can be stored in an optical disc, is commonly known, it is not necessary here to describe this technology in great detail. For understanding the present invention, it is sufficient to mention that the laser beam is modulated such as to cause a pattern of locations where properties of the disc material have changed, such pattern corresponding to coded information.

More particularly, the laser drive signal is a digital signal which can assume one of two values, indicated as HIGH and LOW or “1” and “0”, respectively. If the laser driver signal is LOW, the laser output power is such that it gives rise to a so-called “land” on the disc material. If the laser driver signal is HIGH, the laser output power is such that it gives rise to a so-called “pit”. The translation of the encoder signal to a laser beam control signal is generally termed a write-strategy and is generally performed by a Write Strategy Generator (WSG).

Said optical scanning means comprise an optical pickup unit, which comprises a laser diode and a laser diode driver. The laser diode driver comprises a flipflop device, as well as a Write Strategy Generator and a laser current driver determining the laser diode driving signal. As will be explained in more detail, the flipflop device has two inputs for receiving a data signal and a clock signal, respectively. Briefly stated, the clock signal is a digital signal determining the timing of changes in the flipflop output signal, whereas the data signal determines the value which the flipflop output signal takes at the moments determined by the clock signal.

For reliably setting a flipflop device to a desired state (i.e. HIGH/LOW), such flipflop device requires that the input signals are stable during a certain time window around the active clock signal edge (setup and hold requirements). If these requirements are not met, data errors may occur.

In this respect, some individual flipflop devices may have more strict setup and hold requirements than others. In fact, these requirements may differ from batch to batch and even from device to device. On the other hand, the clock signal and the data signal are provided by an encoder device, and a phase relationship between the clock signal and the data signal may be different for different encoder devices and may even vary with time for one encoder device, caused for instance by variations in temperature or power supply. The problems mentioned above have increasing severity with increasing writing speed (data rate).

Therefore, it is an important objective of the present invention to reduce the chances on data errors by increasing the stability of the clock signal and the data signal during said flipflop-determined time window.

In the state of the art, the encoder provides the clock signal and the data signal at two separate output terminals, and these two signals are transferred to the optical pickup unit over two physically separate transfer paths, i.e. separate lines. Since the encoder is located at a relatively large distance from the optical pickup unit, these two physically separate transfer paths inevitably have an effect on the phase difference between the clock signal and the data signal. This effect is hardly predictable or controllable, and may vary with time and temperature; the effect may be such that timing margins are reduced or even eliminated.

### SUMMARY OF THE INVENTION

It is a general objective to overcome the above-mentioned problems.

More particularly, it is an objective of the present invention to provide an optical recording apparatus capable of high bit rates wherein set-up and hold requirements in a laser driver unit are more easily met.

According to an important aspect of the present invention, this objective is attained by transferring the data signal and information relating to the clock signal over one common transfer path at a fixed phase relationship.

In one embodiment, based on the understanding that the data signal itself contains information relating to a clock signal, only the data signal is transferred, and the optical pickup unit is provided with clock signal regeneration means for regenerating a clock signal from the data signal.

In another embodiment, a combined signal is generated from the data signal and the clock signal, and this combined signal is transferred, while the optical pickup unit is provided with demultiplexing means for regenerating a clock signal and a data signal from the combined signal.

Apart from eliminating or at least reducing the problems regarding phase relationship of data and clock signals, the mere fact that only one signal is transferred over one transfer path already offers additional advantages. One output terminal of the encoder is now free, and can be used for other purposes or can be omitted. In the cable to the optical pickup unit, one high-frequency signal is removed, and this signal (clock signal) is even removed from the entire system except inside the optical pickup unit.

### BRIEF DESCRIPTION OF THE DRAWINGS

These and other aspects, features and advantages of the present invention will be further explained by the following description of the present invention with reference to the drawings, in which same reference numerals indicate same or similar parts, and in which:

FIG. 1 is a block diagram illustrating an optical writing system according to prior art;

FIG. 2 is a graph illustrating an aligned timing relationship between a data signal, a clock signal and a retimed data signal;

FIG. 3A-B are graphs, similar to FIG. 2, illustrating possible mis-alignment;

FIG. 4 is a block diagram schematically illustrating a first embodiment of an optical writing system according to the present invention;

FIG. 5 is a block diagram schematically illustrating a second embodiment of an optical writing system according to the present invention.

### DESCRIPTION OF THE INVENTION

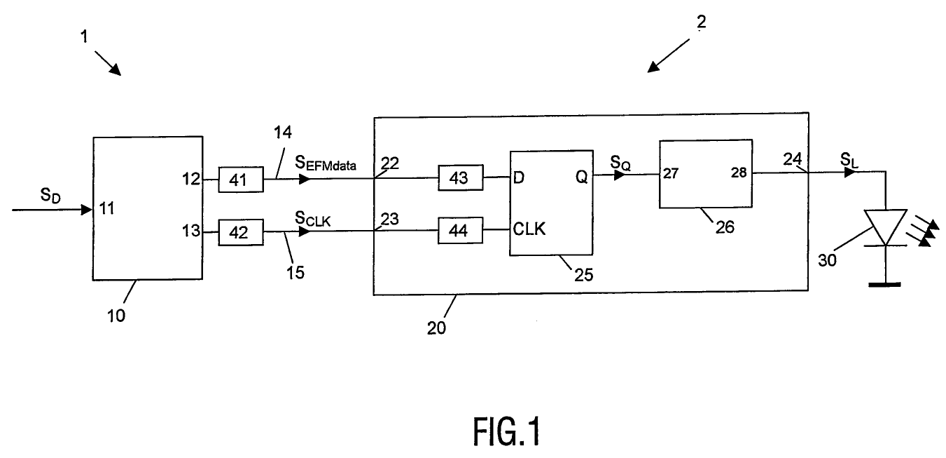

FIG. 1 schematically shows an optical writing system 2 of an optical disc writing apparatus 1 according to prior art. The optical writing system 2 comprises an encoder device 10 having an input 11 for receiving a data signal S_{D} from a data source not shown for sake of simplicity. The encoder 10 performs a coding operation, typically the well-known eight-to-fourteen modulation coding (EFM), and provides an EFM data signal S_{EFMdata} at a data output 12 and an EFM clock signal S_{CLK} at a clock output 13. Since eight-to-fourteen modulation coding is known per se, it is not necessary here to explain this coding scheme in detail.

The optical writing system 2 further comprises a laser diode 30 and a driver circuit 20 for driving the laser diode 30. The driver circuit 20 has a data input 22 coupled to the data output 12 of the encoder 10 for receiving the data signal S_{EFMdata}, and has a clock input 23 coupled to the clock output 13 of the encoder 10 for receiving the clock signal S_{CLK}. The driver circuit 20 further has a drive output 24 coupled to the laser diode 30, providing a laser diode drive signal S_{L}.

As shown in FIG. 1, the driver circuit 20 comprises a laser current driver unit 26, which has an input 27 and an output 28 connected to the drive output 24 of the driver circuit 20. The laser current driver unit 26 in this example comprises a write strategy generator, which is not shown individually.

As shown in FIG. 1, the driver circuit 20 further comprises a D-type flipflop drive device 25, having a data input D coupled to data input 22 of the driver circuit 20, having a clock input CLK coupled to clock input 23 of the driver circuit 20, and having an output Q coupled to the input 27 of the laser current driver unit 26.

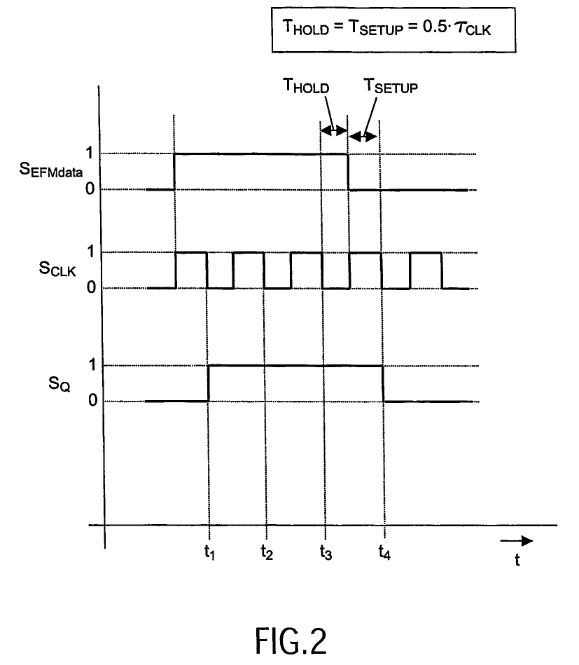

FIG. 2 schematically illustrates the operation of the driver circuit 20. The coded data signal S_{EFMdata} is a digital signal which can take two values, indicated as HIGH and LOW or as “1” and “0”, respectively; transitions between these two values are indicated as signal edges. Likewise, the clock signal S_{CLK} is a digital signal which can take two values, indicated as HIGH and LOW or as “1” and “0”, respectively; transitions between these two values are likewise indicated as signal edges. In both cases, a transition from “0” to “1” will be indicated as a rising edge, while a transition from “1” to “0” will be indicated as a falling edge.

Each time a falling edge of the clock signal S_{CLK} is received at its clock input CLK, the D-type flipflop device 25 makes the value of its output signal at its output Q equal to the instantaneous value of the data signal S_{EFMdata} at its data input D, and this output signal is maintained until the next arrival of a falling edge of the clock signal S_{CLK}. Thus, at time t1 in FIG. 2, flipflop output signal S_{Q} becomes high. At times t2 and t3, flipflop output signal S_{Q} remains high because the data signal S_{EFMdata} at flipflop data input D is still high, but at time t4 flipflop output signal S_{Q} becomes low because now the data signal S_{EFMdata} at flipflop data input D is low. Flipflop output signal S_{Q} can be considered to establish a data signal similar to the data signal S_{EFMdata} but with a different timing, for which reason flipflop output signal S_{Q} is also indicated as retimed data signal.

In the situation shown in FIG. 2, since the flipflop device 25 is responsive to falling edges of the clock signal, the falling edges of the clock signal are indicated as active edges whereas the rising edges of the clock signal are indicated as inactive edges.

In the following, two timing parameters will be defined. A first timing parameter is the time difference between an edge of the data signal S_{EFMdat} and the next active edge of the clock signal S_{CLK}, indicated as setup time T_{SETUP}. This timing parameter indicates the time that a changing data signal is stable before the occurrence of the next active edge of the clock signal S_{CLK}.

A second timing parameter is the time difference between an edge of the data signal S_{EFMdat} and the previous active edge of the clock signal S_{CLK}, indicated as hold time T_{HOLD}. This timing parameter indicates the time that a data signal remains stable after the occurrence of the previous active edge of the clock signal S_{CLK}.

In the situation shown in FIG. 2, edges of the data signal S_{EFMdata} are aligned with the inactive edges of the clock signal S_{CLK}. In that case, T_{SETUP} and T_{HOLD} are both equal to half the clock period τ_{CLK}.

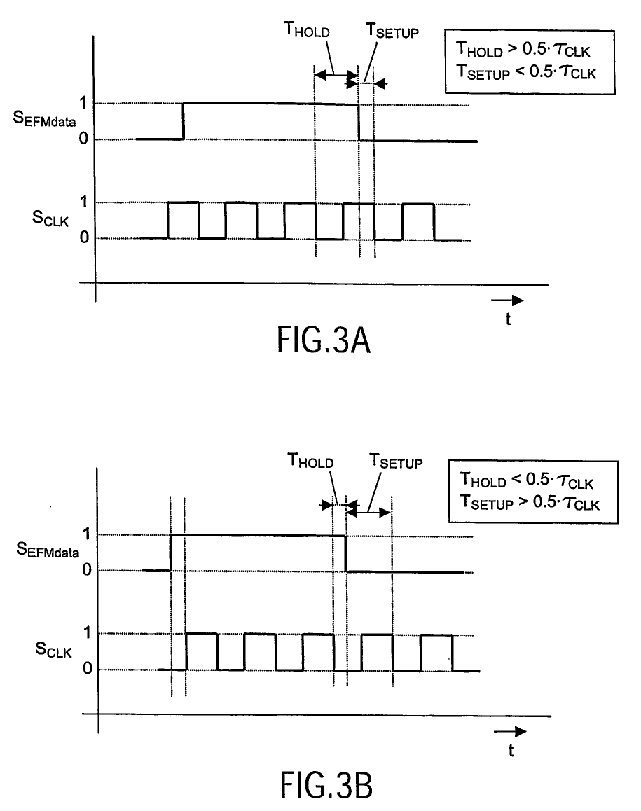

FIG. 3A illustrates a situation where the edges of the data signal S_{EFMdata} arrive somewhat later than the inactive edges of the clock signal S_{CLK}; in this case, T_{SETUP}<0.5·τ_{CLK} and T_{HOLD}>0.5·τ_{CLK}.

FIG. 3B illustrates a situation where the edges of the data signal S_{EFMdata} arrive somewhat earlier than the inactive edges of the clock signal S_{CLK}; in this case, T_{SETUP}>0.5·τ_{CLK} and T_{HOLD}<0.5·τ_{CLK}.

With respect to setup and hold time requirements of the flipflop 25, the situation of FIG. 2 is ideal, because then the smallest of T_{SETUP} and T_{HOLD} is maximal.

In the case of a static delay between data and clock, T_{SETUP} and T_{HOLD} are not equal to each other. It is noted that, in that case, it could be better to take the rising edges as active edges, depending on the magnitude of the delay, which can be achieved by inverting the clock signal.

The setup and hold times may vary from device to device, while for one device the setup and hold times may vary with time. This is represented by internal delays 41 and 42 at the outputs 12 and 13 of the encoder 10, and by internal delays 43 and 44 at the inputs 22 and 23 of the driver 20. Internal delays 41 and 42 represent timing differences as occurring inside the encoder 10, whereas internal delays 43 and 44 represent timing differences as caused by the signal transfer between encoder 10 and flipflop 25.

In this respect, it is noted that, in the prior art, the data signal S_{EFMdata} and the clock signal S_{CLK} are transferred from the encoder 10 (outputs 12 and 13) to the driver 20 (inputs 22 and 23) over two physically separate transfer paths 14 and 15, i.e. separate lines, which are relatively long. As a consequence, the internal delays 43 and 44 associated with these two separate signal lines 14 and 15 may vary appreciably, causing variations in the phase difference between the clock signal and the data signal, which limits the maximal bit rate of the data signal.

It is generally desirable to have each of the setup and hold times T_{SETUP} and T_{HOLD} as measured at the D and CLK inputs of flipflop 25 to be as large as possible. This requirements implies that it is desirable to assure that edges of the data signal S_{EFMdata} are substantially aligned with the inactive edges of the clock signal S_{CLK}. On the other hand, depending on the design of the system, it may be desirable that a certain predefined time difference exists between the inactive edges of the clock signal S_{CLK}. In any case, it is desirable that the setup and hold times T_{SETUP} and T_{HOLD} as measured at the D and CLK inputs of flipflop 25 are as constant as possible.

To this end, the present invention provides an optical writing system in which internal delays 41 and 42 inside the encoder 10 are substantially eliminated, and in which the effect of internal delays 43 and 44 between encoder 10 and driver 20 is substantially reduced. According to the present invention, only one signal is transferred from encoder to driver, this one signal containing information of data signal and clock signal.

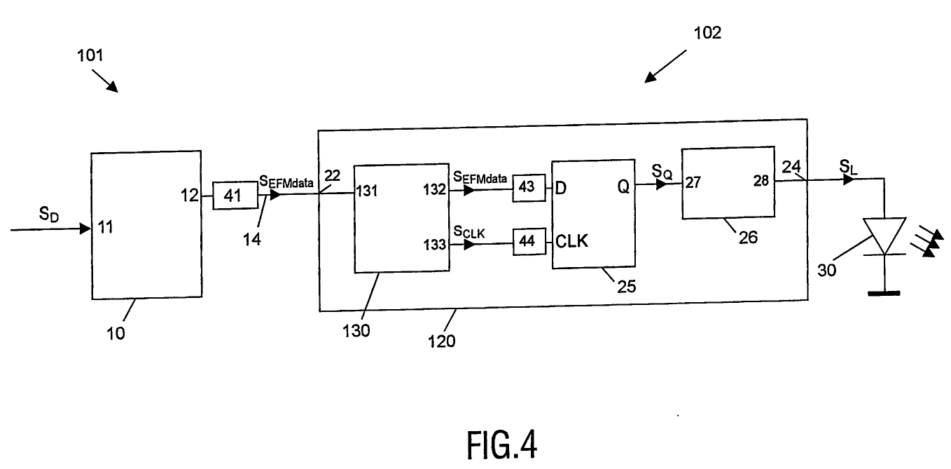

FIG. 4 is a block diagram schematically illustrating a first embodiment of an optical disc writing apparatus 101 with an optical writing system 102 according to the present invention. In this first embodiment, said one signal is the data signal S_{EFMdata} itself, and a driver 120 of the optical writing system 102 is provided with clock signal regeneration means 130 for regenerating a clock signal from the data signal.

More specifically, the optical writing system 102 comprises an encoder 10 which may be identical to the prior art encoder 10 as discussed with reference to FIG. 1, providing the EFM data signal S_{EFMdata} at its data output 12. The clock signal provided at its clock output 13 is not used, and the clock output 13 is not connected to any terminal of the driver 120. Thus, it is also possible to use an encoder which does not have a clock output terminal.

The driver 120 comprises a clock signal regenerator 130, having an input 131 connected to the data input 22 of the driver 120 to receive the data signal S_{EFMdata}, and having a data output 132 and a clock output 133. The clock signal regenerator 130 is designed to regenerate a clock signal on the basis of the data signal received. Since such clock regenerator devices are known per se, as they are commonly used in the read channel of an optical disc reader apparatus, and since it is possible to use such existing clock regenerator devices for implementing the present invention, it is not necessary here to describe the design and operation of a clock regenerator device in more detail.

The data input D of the flipflop 25 is coupled to the data output 132 of the clock signal regenerator 130, and the clock input CLK of the flipflop 25 is coupled to the clock output 133 of the clock signal regenerator 130. Thus, the flipflop 25 receives both a data signal and a clock signal, and the operation of the flipflop 25 is identical to the operation as explained with reference to FIG. 1.

Since only one signal is transferred from the encoder 10 to the driver 120, any internal delay 41 within the encoder 10 or in the transfer path 14 does not play any role in the phase relationship between data signal and clock signal. Since the transfer paths from regenerator 130 to flipflop 25 are very short, the internal delays 43 and 44 occurring within the driver 120 are very small, and possible variations with time, or as a function of temperature, will be very small, if existing at all.

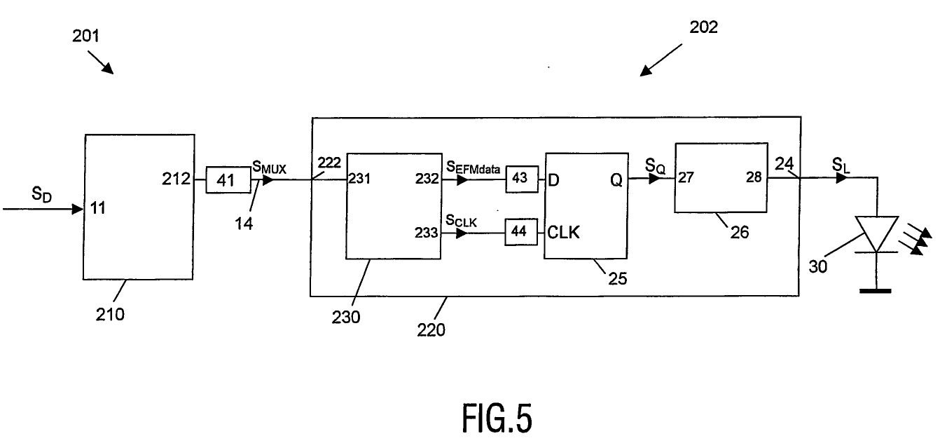

FIG. 5 is a block diagram schematically illustrating a second embodiment of an optical disc writing apparatus 201 with an optical writing system 202 according to the present invention. In this second embodiment, said one signal is a combined signal generated from the data signal and the clock signal, and a driver 220 of the optical writing system 202 is provided with demultiplexing means 230 for regenerating a clock signal and a data signal from the combined signal.

More specifically, the optical writing system 202 comprises an encoder 210 having a combined signal output 212 for providing a combined signal S_{MUX} which is based on a combination of the EFM data signal S_{EFMdata} and the clock signal S_{CLK} as discussed above with reference to FIG. 1. It is noted that, like the encoder 10 of the first embodiment 102, the encoder 210 needs to have only one output for implementation in the present invention.

It is noted that several solutions exist in the art for multiplexing two digital signals into one signal, and for demultiplexing this one signal into two original data signals, and many of those existing solutions are applicable when implementing the present invention. Therefore, elaborate descriptions of possible multiplexing devices and corresponding demultiplexing devices are omitted here. It is sufficient to mention some examples.

In a simple embodiment, the combined signal S_{MUX} may be a 4-level signal, generated from the EFM data signal S_{EFMdata} and the clock signal S_{CLK} in accordance with the following table:

| S_{EFMdata} | S_{CLK} | S_{MUX} |
|---|---|---|
| 0 | 0 | 0 |
| 0 | 1 | 1 |
| 1 | 0 | 2 |
| 1 | 1 | 3 |

In another simple embodiment, the combined signal S_{MUX} may be a 3-level signal, generated from the EFM data signal S_{EFMdata} and the clock signal S_{CLK} in accordance with the following table:

| S_{EFMdata} | S_{CLK} | S_{MUX} |
|---|---|---|
| 0 | 0 | 0 |
| 0 | 1 | 1 |
| 1 | 0 | 0 |
| 1 | 1 | 2 |

In both cases, the encoder 210 can be simply designed with just a few relatively simple components, as will be clear to a person skilled in the art when referring to the above tables.

The combined signal S_{MUX} can be considered as a multiplexed signal. The driver 220 comprises a demultiplexer 230, having an input 231 connected to the signal input 222 of the driver 220 to receive the combined signal S_{MUX}, and having a data output 232 and a clock output 233. The demultiplexer 230 is designed to regenerate a data signal S_{EFMdata} and a clock signal S_{CLK} on the basis of the combined signal received. The demultiplexer 230 can be simply designed with just a few relatively simple components, as will be clear to a person skilled in the art when referring to the above tables. Therefore, it is not necessary here to describe the design and operation of a demultiplexer in more detail.

The data input D of the flipflop 25 is coupled to the data output 232 of the demultiplexer 230, and the clock input CLK of the flipflop 25 is coupled to the clock output 233 of the demultiplexer 230. Thus, the flipflop 25 receives both a data signal and a clock signal, and the operation of the flipflop 25 is identical to the operation as explained with reference to FIG. 1.

Since only one combined signal is transferred from the encoder 10 to the driver 220, the phase relationship between clock signal and data signal as determined by the encoder 210 is fixed during transfer to the driver 220. Any internal delay 41 within the encoder 210 or in the transfer path 14 does not play any role in the phase relationship between data signal and clock signal. Since the transfer paths from demultiplexer 230 to flipflop 25 are very short, the internal delays 43 and 44 occurring within the driver 220 are very small, and possible variations with time, or as a function of temperature, will be very small, if existing at all.

The second embodiment of FIG. 5 has an advantage over the first embodiment of FIG. 4 in that the demultiplexer 230 has a simpler design than the regenerator 130. On the other hand, the encoder 210 of the second embodiment has a slightly increased complexity with respect to the encoder 10 of the first embodiment.

Thus, the present invention provides an optical recording apparatus 101; 201, for writing information to an optical storage medium such as for instance an optical disc, the apparatus comprising a laser diode 30, an encoder device 10; 210, and a laser driver circuit 120; 220 which comprises a flipflop device 25, a write strategy generator and a laser current driver 26.

A single encoded signal S_{EFMdata}; S_{MUX} containing data information and clock information is transferred over one common transfer path 14 from the encoder 10; 210 to the driver circuit 120; 220, which further comprises signal generator means 130; 230 designed to generate a digital data signal S_{EFMdata} and a digital clock signal S_{CLK} from the single encoded signal received from the encoder.

It should be clear to a person skilled in the art that the present invention is not limited to the exemplary embodiments discussed above, but that various variations and modifications are possible within the protective scope of the invention as defined in the appending claims.

For instance, the flipflop 25 may be integrated in the regenerator 130 or the demultiplexer 230, respectively.

Further, in the first embodiment of FIG. 4, it is in principle possible that the regenerator 130 does itself output the data signal S_{EFMdata}, but that the data input D of the flipflop 25 is connected to the driver input 22.

Further, it is noted that the output signal of driver circuit 20 may be inverted with respect to the EFM data signal.

Also, the flipflop device 25 may respond to rising edges of the clock signal, in which case phase difference zero corresponds to alignment of data signal edges with falling clock signal edges.

Further, it is possible that the optical writing system 2 comprises an inverter arranged between clock signal output 133; 233 of the signal generator 130; 230 and clock signal input CLK of the flipflop 25, in order to effect that rising edges in the clock signal S_{CLK} become falling edges in the clock signal S4 as appearing at the clock signal input CLK of the flipflop 25, and vice versa. Such inverter is preferably a controllable inverter, for instance implemented as an EXOR gate, receiving the clock signal S_{CLK} at one input terminal and receiving a selection signal at a second input terminal, as will be clear to a person skilled in the art. With such controllable inverter, it is possible to select either the falling edges or the rising edges of the encoder output clock signal S_{CLK} as active edge, depending on whether the data signal edges are closer to the falling edges or the rising edges of the encoder output clock signal S_{CLK}.

Further, it is noted that the invention is applicable in optical recording apparatus for write-once recording material as well as for rewritable recording material.

Further, it is noted that the invention is not limited to recording material in the shape of rotating discs.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Optical writing system (102; 202) for an optical disc writing apparatus (101; 201), comprising:
an encoder device (10; 210) having an input (11) for receiving a data signal (S_{D}) and an output (12; 212) for providing a single encoded signal (S_{EFMdata}; S_{MUX}) which contains data information and clock information;
a laser driver circuit (120; 220) having a signal input (22; 222) for receiving an encoded signal (S_{EFMdata}; S_{MUX}) from the encoder device (10; 210) and comprising a flipflop device (25) with a data input (D) for receiving a digital data signal (S_{EFMdata}), and a clock input (CLK) for receiving a digital clock signal (S_{CLK}), wherein the laser driver circut (120; 220) further comprises signal generator means (130; 230) having a signal input (131; 231) coupled to the signal input (22; 222) of the driver circuit (20; 220), a data output (132; 232) coupled to the data input (D) of the flipflop (25), and a clock output (133; 233) coupled to the clock input (CLK) of the flipflop (25);
the signal generator means (130; 230) being designed to generate at its data and clock outputs a digital data signal and a digital clock signal, respectively, from an encoded signal received at its signal input.

2. Optical writing system (102) according to claim 1, wherein the encoder device (10) is designed to generate at its output (12) a digital data signal (S_{EFMdata}), and wherein the signal generator means (130) comprises clock signal regenerator means (130) designed for deriving a digital clock signal (S_{CLK}) from a digital data signal (S_{EFMdata}).

3. Optical writing system (102) according to claim 2, wherein the flipflop (25) and the regenerator means (130) are integrated into one unit.

4. Optical writing system (202) according to claim 1, wherein the encoder device (210) is designed to generate at its output (212) a combined signal (S_{MUX}) which is based on a combination of a digital data signal (S_{EFMdata}) and a digital clock signal (S_{CLK}), and wherein the signal generator means (230) comprises demultiplexing means (230) designed to regenerate a data signal (S_{EFMdata}) and a clock signal (S_{CLK}) from a combined signal (S_{MUX}) as coded by the encoder (210).

5. Optical writing system (202) according to claim 4, wherein the flipflop (25) and the demultiplexing means (230) are integrated into one unit.

6. Optical writing system according to claim 1, wherein the signal generator means (130; 230) is arranged immediately before the flipflop device (25).

7. Optical recording apparatus (101; 201) for writing information to an optical storage medium, comprising an optical writing system according to claim 1.

8. Method for applying a digital data signal (S_{EFMdata}) and a digital clock signal (S_{CLK}) to a flipflop device (25) of a laser driver circuit (120; 220), the method comprising the steps of:
providing a single encoded signal (S_{EFMdata}; S_{MUX}) which contains data information and clock information;
transferring said single encoded signal (S_{EFMdata}; S_{MUX}) to the laser driver circuit (120; 220);
deriving a digital data signal (S_{EFMdata}) and a digital clock signal (S_{CLK}) from said single encoded signal (S_{EFMdata}; S_{MUX});
applying the derived digital data signal (S_{EFMdata}) and the derived digital clock signal (S_{CLK}) to said flipflop device (25).

9. Method according to claim 8, wherein said single encoded signal (S_{EFMdata}; S_{MUX}) is the digital data signal (S_{EFMdata})

10. Method according to claim 8, the method comprising the steps of:
generating a digital data signal (S_{EFMdata}) and a digital clock signal (S_{CLK});
multiplexing these two signals into one single encoded signal (S_{MUX});
transferring said single encoded signal (S_{MUX}) to the laser driver circuit (120; 220);
demultiplexing said single encoded signal (S_{MUX}) to regenerate a digital data signal (S_{EFMdata}) and a digital clock signal (S_{CLK});
applying the regenerated digital data signal (S_{EFMdata}) and the regenerated digital clock signal (S_{CLK}) to said flipflop device (25).
